(19) United States
(12) Patent Application Publication
(10) Pub. No.: US 2025/0070897 A1
(43) Pub. Date: Feb. 27, 2025

(54) CONTROL SYSTEM AND MANAGEMENT APPARATUS

(71) Applicant: KABUSHIKI KAISHA TOKAI RIKA DENKI SEISAKUSHO, Aichi (JP)

(72) Inventors: Takuji TATSUYAMA, Aichi (JP); Tadayuki TOBIMATSU, Aichi (JP); Yosuke DOI, Aichi (JP); Taichi NAKAO, Shizuoka (JP); Akira TOKUNAGA, Shizuoka (JP)

(73) Assignee: KABUSHIKI KAISHA TOKAI RIKA DENKI SEISAKUSHO, Aichi (JP)

(21) Appl. No.: 18/799,100

(22) Filed: Aug. 9, 2024

(30) Foreign Application Priority Data
Aug. 24, 2023 (JP) 2023-136195

(51) Int. Cl. H04B 17/318; G06F 8/65

(52) U.S. Cl. CPC H04B 17/318; G06F 8/65

(57) ABSTRACT

There is provided a control system comprising: a non-transitory computer readable storage medium storing a program that causes a computer to implement an extraction function of extracting correction information from a correction table on a basis of model information for a portable apparatus, the correction information being used to correct radio wave strength of signals that are transmitted and received between a mobile body and the portable apparatus, the correction table being updated and managed by a server; and a determination device configured to determine on a basis of radio wave strength whether or not to cause a control target device to execute a prescribed operation, the radio wave strength being corrected by using the correction information, the control target device being mounted on the mobile body.

### CROSS REFERENCE TO RELATED APPLICATION(S)

This application is based upon and claims benefit of priority from Japanese Patent Application No. 2023-136195, filed on Aug. 24, 2023, the entire contents of which are incorporated herein by reference.

### BACKGROUND

The present invention relates to a control system and a management apparatus.

In recent years, technology that estimates the distance to a portable apparatus on the basis of the received radio wave strength of a signal received from the portable apparatus has been under development. Portable apparatuses may, however, vary in output radio wave strength depending on models or the like. Accordingly, JP 2019-32169A discloses technology that increases the estimation precision by leveling the received radio wave strengths of signals received from portable apparatuses on the basis of pieces of correction information.

### SUMMARY

The technology disclosed in JP 2019-32169A calculates each of the pieces of correction information on the basis of an operation on a portable apparatus by a user. However, noise or the like has great influence in some environments for measuring radio waves for calculating the correction information. In addition, a correct measurement condition is not satisfied by the operation by the user in some cases. The measurement technique as disclosed in JP 2019-32169A can therefore offer varying measurement results.

Accordingly, the present invention has been devised in view of the problem described above. An object of the present invention is to effectively manage correction information having high precision.

To solve the above described problem, according to an aspect of the present invention, there is provided a control system comprising: a non-transitory computer readable storage medium storing a program that causes a computer to implement an extraction function of extracting correction information from a correction table on a basis of model information for a portable apparatus, the correction information being used to correct radio wave strength of signals that are transmitted and received between a mobile body and the portable apparatus, the correction table being updated and managed by a server; and a determination device configured to determine on a basis of radio wave strength whether or not to cause a control target device to execute a prescribed operation, the radio wave strength being corrected by using the correction information, the control target device being mounted on the mobile body.

To solve the above described problem, according to another aspect of the present invention, there is provided a management apparatus comprising a management unit configured to manage correction information and model information for a portable apparatus in association with each other, the correction information being used to correct radio wave strength of signals that are transmitted and received between a mobile body and the portable apparatus, wherein radio wave strength corrected by using the correction information is used to determine whether or not to cause a control target device to execute a prescribed operation, the control target device being mounted on the mobile body.

As described above, according to the present invention, it is possible to effectively manage correction information having high precision.

### BRIEF DESCRIPTION OF THE DRAWINGS

FIG. 1 is a block diagram illustrating a functional configuration example of a control system 1 according an embodiment of the present invention.

FIG. 2 is a diagram illustrating an example of a correction table 50 according to the embodiment.

FIG. 3 is a sequence diagram illustrating an example of a flow of communication for distance estimation that includes a correction process according to the embodiment.

FIG. 4 is a diagram illustrating an example of a flow of processes performed in a case where the correction table 50 according to the embodiment is stored only in a management apparatus 30.

FIG. 5 is a sequence diagram illustrating an example of a flow of processes performed in a case where the correction table 50 according to the embodiment is also preserved in a control application 220 installed in a portable apparatus 20.

FIG. 6 is a sequence diagram illustrating an example of a flow of processes performed in a case where the correction table 50 according to the embodiment is also preserved in a control device 120.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

### 1.1. Functional Configuration Example

First, a functional configuration example of a control system 1 according an embodiment of the present invention will be described.

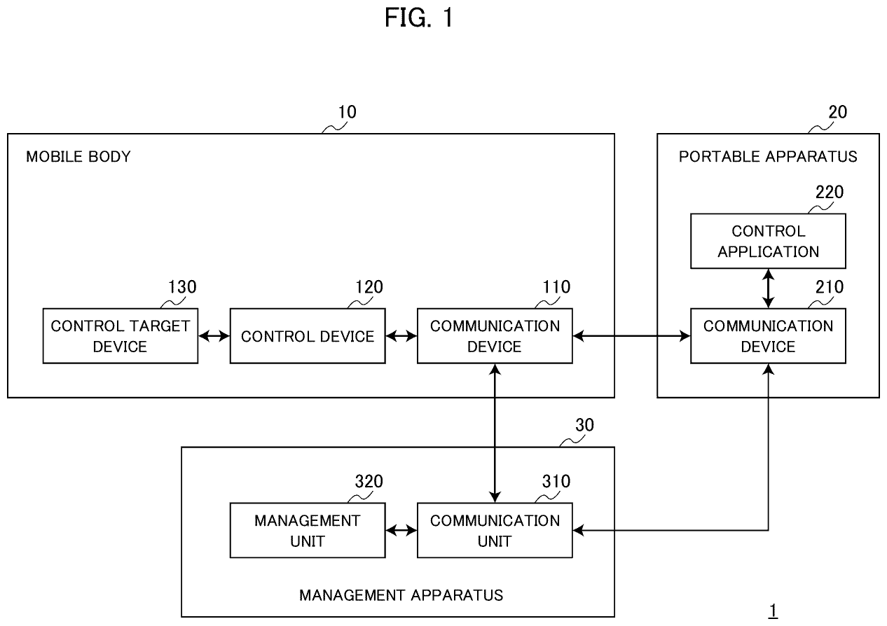

FIG. 1 is a block diagram illustrating the functional configuration example of the control system 1 according an embodiment of the present invention.

As illustrated in FIG. 1, the control system 1 according to the present embodiment includes a mobile body 10, a portable apparatus 20, and a management apparatus 30.

### (Mobile Body 10)

The mobile body 10 according to the present embodiment may be, for example, a vehicle such as a car, an aircraft, or a vessel.

It should be noted that the mobile body 10 according to the present embodiment is an example of a control target which transmits and receives signals to and from the portable apparatus 20.

The control target according to the present invention is not, however, limited to the mobile body 10. The control target may be, for example, a building or the like such as a door including a control target device 130.

### (Communication Device 110)

A communication device 110 according to the present embodiment performs wireless communication compliant with a prescribed communication standard with a communication device 210 mounted on the portable apparatus 20.

The prescribed communication standard may be, for example, Bluetooth (registered trademark) Low Energy (BLE).

The prescribed communication standard is not, however, limited to the example described above and any communication standard may be set.

In addition, the communication device 110 according to the present embodiment may perform wireless communication with a communication unit 310 included in the management apparatus 30.

### (Control Device 120)

A control device 120 according to the present embodiment controls at least the above-described wireless communication by the communication device 110.

In addition, the control device 120 according to the present embodiment functions as a determination device that determines whether or not to cause the control target device 130 to execute a prescribed operation on the basis of the received radio wave strength (RSSI: Received Signal Strength Indicator) of a signal received by the communication device 110 from the communication device 210.

For example, in a case where the RSSI of a signal received by the communication device 110 from the communication device 210 exceeds a threshold, the control device 120 according to the present embodiment may determine that the portable apparatus 20 is located within a predetermined distance from the mobile body 10 and cause the control target device 130 to execute the prescribed operation.

Further, the control device 120 may authenticate the portable apparatus 20 on the basis of information such as a digital key received by the communication device 110 from the communication device 210 in addition to the determination based on the RSSI as described above and determine whether or not to execute the prescribed operation further on the basis of a result of the authentication.

In this case, the control device 120 causes the control target device 130 to execute the prescribed operation in a case where the RSSI described above exceeds the threshold and the authenticity of the portable apparatus 20 is proved in the authentication described above.

The control device 120 according to the present embodiment is implemented by a variety of electronic control units (ECUs).

### (Portable Apparatus 20)

The portable apparatus 20 according to the present embodiment is carried by a user (e.g., an owner of the mobile body 10, a person who is permitted by the owner to use the mobile body 10, or the like) of the mobile body 10.

The portable apparatus 20 according to the present embodiment may be, for example, a smartphone, a tablet, a wearable device, or the like.

### (Communication Device 210)

The communication device 210 according to the present embodiment performs wireless communication compliant with a prescribed communication standard with the communication device 110 mounted on the mobile body 10.

In addition, the communication device 210 according to the present embodiment may perform wireless communication with the communication unit 310 included in the management apparatus 30.

### (Control Application 220)

A control application 220 according to the present embodiment may have a program that carries out a correction process of correcting the radio wave strength of signals transmitted and received between the mobile body 10 and the portable apparatus 20 on the basis of correction information stored in the portable apparatus 20.

Details of the correction process according to the present embodiment will be described below.

### (Management Apparatus 30)

The management apparatus 30 according to the present embodiment is a server that updates and manages a correction table in which correction information that is used to correct the radio wave strength of signals transmitted and received between the mobile body 10 and the portable apparatus 20 and model information for the portable apparatus 20 are recorded in association with each other.

### (Communication Unit 310)

The communication unit 310 according to the present embodiment performs wireless communication with at least one of the communication device 110 mounted on the mobile body 10 or the communication device 210 mounted on the portable apparatus 20.

### (Management Unit 320)

A management unit 320 according to the present embodiment updates and manages the correction table described above.

In addition, the management unit 320 according to the present embodiment distributes the correction table or the correction information.

Details of the distribution of the correction table according to the present embodiment and the distribution of the correction information according to the present embodiment will be described below.

The functional configuration example of the control system 1 according the present embodiment has been described above. It should be noted that the functional configuration described above with reference to FIG. 1 is merely an example. The functional configuration of the control system 1 according to the present embodiment is not limited to the example.

It is possible to flexibly modify the functional configuration of the control system 1 according to the present embodiment in accordance with the specifications, the operations, and the like.

### 1.2. Correction Table

Next, the correction table according to the present embodiment will be described.

As described above, measurement results can vary in some environments for measuring radio waves for calculating the correction information. The variation in measurement results as described above leads to a decrease in the precision of the correction information calculated on the basis of the measurement results and eventually a decrease in the estimation precision of the distance between the mobile body 10 and the portable apparatus 20 (more accurately, between the communication device 110 and the communication device 210).

Meanwhile, ensuring the estimation precision of the distance described above has been recently more important such as a request to be adapted to the provisions such as UN Regulation No. 116.

The technical idea of the present invention has been conceived of in view of the points as described above and makes it possible to effectively manage correction information having high precision.

Therefore, the correction information according to the present embodiment is calculated in advance on the basis of results obtained by measuring the radio wave characteristics and the output radio wave strength of the portable apparatus 20 by a digital key provider or the like in a predetermined reliable environment and method.

In addition, the correction information having high precision (i.e., the correction information that varies less as described above) calculated as described above is stored in the correction table in association with the model information for the portable apparatus 20.

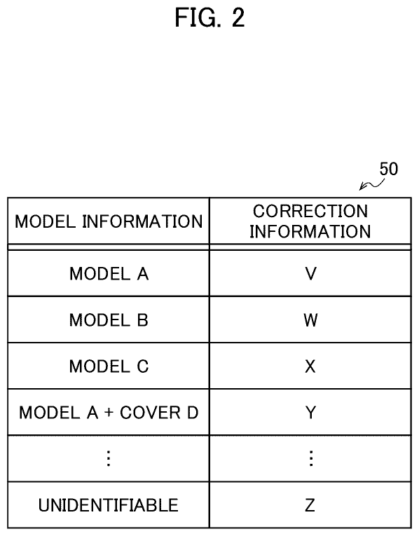

FIG. 2 is a diagram illustrating an example of a correction table 50 according to the present embodiment.

As illustrated in FIG. 2, the correction table 50 according to the present embodiment stores information for identifying the model of the portable apparatus 20 and correction information calculated in advance by using the model in association with each other like model information “model A” and correction information “V”, model information “model B” and correction information “W”, model information “model C” and correction information “X”.

In addition, as illustrated in FIG. 2, the model information according to the present embodiment may include, for example, information for identifying a cover, a case, or the like that is worn on the portable apparatus 20 in addition to the information for identifying the model. It is possible to effectively correct the output radio wave strength that may vary depending on a cover, a case, or the like.

In addition, as illustrated in FIG. 2, the correction table 50 according to the present embodiment may store correction information “Z” that is used in a case where the model of the portable apparatus 20 is “unidentifiable”.

For example, in a case where correction information for a newly released model has not yet been registered in the correction table 50, a correction process in which the correction information “Z” is used may be executed.

That is, the correction information “Z” may be provisional correction information that is used before correction information for a certain model is registered in the correction table 50.

It should be noted that the correction information “Z” may be information for correcting the radio wave strength that has a reasonable margin necessary for complying with the variety of provisions.

The correction information “Z” includes correction information “Z1” for making a correction to weaken the radio wave strength. The correction information “Z1” is effective especially for the model of the portable apparatus 20 whose radio wave strength has not been measured in the past in a predetermined environment and method.

In addition, the correction information “Z” includes correction information “Z2” for making a correction to strengthen the radio wave strength.

The radio wave strengths of some models of the portable apparatuses 20 can be weaker than expected (a certain threshold).

The correction information “Z2” for making a correction to strengthen the radio wave strength may be therefore applied to a model whose radio wave strength measured in the past in the predetermined environment and method is less than the certain threshold.

It should be noted that the measurement of the radio wave strength in the predetermined environment and method is performed with the distance between the communication device 110 and the portable apparatus 20 kept constant. Examples of possible methods for keeping the distance constant include placing the portable apparatus 20 at a predetermined position, bringing the portable apparatus 20 into contact with a predetermined place, and the like.

### 1.3. Correction Process

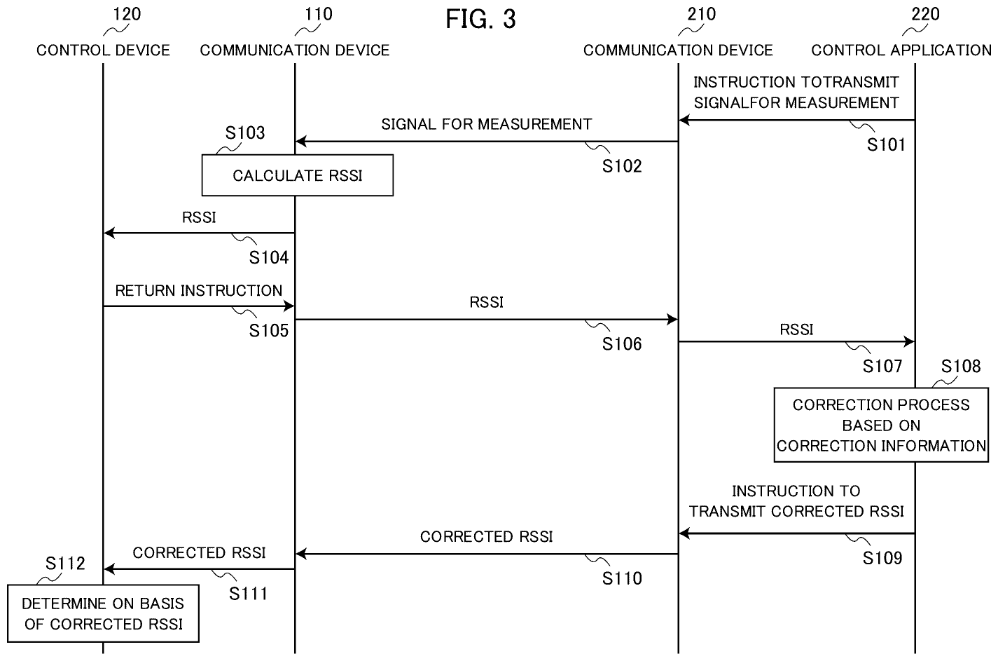

Next, a correction process in which correction information extracted from the correction table 50 according to the present embodiment is used will be described. FIG. 3 is a sequence diagram illustrating an example of a flow of communication for distance estimation that includes a correction process according to the present embodiment.

In the case of the example illustrated in FIG. 3, the control application 220 mounted on the portable apparatus 20 first outputs, to the communication device 210, an instruction to transmit a signal (a signal whose received radio wave strength (RSSI: Received Signal Strength Indicator) is to be calculated) for measurement on the basis of an operation or the like by a user (S101).

The communication device 210 transmits the signal for measurement on the basis of the instruction to transmit the signal for measurement that is inputted in step S101 (S102).

The communication device 110 that receives the signal for measurement in step S102 calculates the RSSI of the signal for measurement (S103).

The communication device 110 outputs the RSSI of the signal for measurement calculated in step S103 to the control device 120 (S104).

Next, the control device 120 outputs, to the communication device 110, a return instruction to return the RSSI calculated in step S103 to the communication device 210 (S105).

The communication device 110 transmits the RSSI calculated in step S103 to the communication device 210 on the basis of the return instruction inputted in step S105 (S106).

The communication device 210 that receives the RSSI in step S106 relays the RSSI to the control application 220 (S107).

The control application 220 executes a correction process of correcting the RSSI inputted in step S107 on the basis of the correction information extracted from the correction table 50 on the basis of the model information about the portable apparatus 20 (S108).

Next, the control application 220 outputs, to the communication device 210, an instruction to transmit the corrected RSSI obtained through the correction process in step S108 (S109).

The communication device 210 transmits the corrected RSSI to the communication device 110 on the basis of the transmission instruction inputted in step S109 (S110).

The communication device 110 relays the corrected RSSI received in step S110 to the control device 120 (S111).

The control device 120 determines on the basis of the corrected RSSI inputted in step S111, that is, the radio wave strength subjected to the correction process whether or not to cause the control target device 130 to execute a prescribed operation (S112).

As described above, the control application 220 according to the present embodiment may perform control to correct the received radio wave strength of a signal received by the mobile body 10 from the portable apparatus 20 on the basis of the correction information and transmit the corrected received radio wave strength to the mobile body 10.

The series of processes as described above makes it possible to increase the estimation precision while reducing the memory usage of the ECU.

Meanwhile, the correction process illustrated in FIG. 3 is merely an example. The correction process according to the present embodiment is not limited to the example.

The correction process of correcting the received radio wave strength of a signal received by the mobile body 10 from the portable apparatus 20 on the basis of the correction information may be carried out by the control device 120.

In addition, the correction process according to the present embodiment may be a process of controlling the output radio wave strength of a signal transmitted by the portable apparatus 20 on the basis of the correction information.

The correction table 50 according to the present embodiment allows any of the examples described above to be implemented.

### 1.4. Operation of Correction Table 50

Subsequently, an operation of the correction table 50 according to the present embodiment will be described with reference to a specific example.

The operation of the correction table 50 is considered to have some variations.

First, a case where the correction table 50 is stored only in the management apparatus 30 will be described.

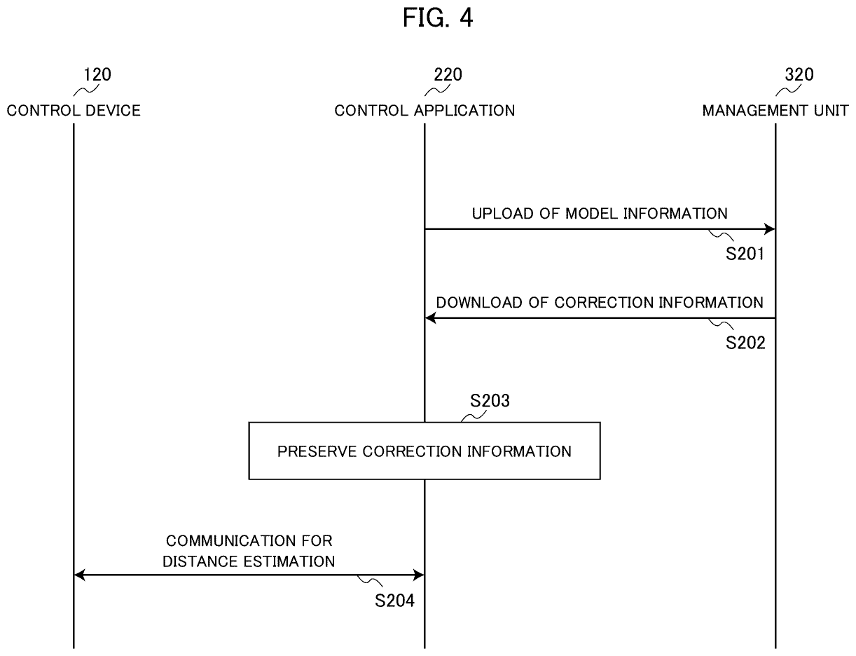

FIG. 4 is a diagram illustrating an example of a flow of processes performed in a case where the correction table 50 according to the present embodiment is stored only in the management apparatus 30.

In the case of the example illustrated in FIG. 4, the management apparatus 30 including the management unit 320 may be, for example, a server that distributes a digital key.

It should be noted that FIG. 4 and the subsequent diagrams omit the description about the communication device 110, the communication device 210, and the communication unit 310 in consideration of visual recognizability, but the respective pieces of information are transmitted and received through the respective components described above.

In the case of the example illustrated in FIG. 4, the control application 220 controls the upload of the model information about the portable apparatus 20 to the management apparatus 30 including the management unit 320 (S201).

The control described above may be carried out automatically when the digital key is used or may be carried out on the basis of an operation by a user.

The management unit 320 that receives the model information about the portable apparatus 20 in step S201 extracts the correction information from the correction table 50 by using the model information as a key and performs control to cause the extracted correction information to be downloaded to the control application 220 (S202).

It should be noted that the management unit 320 may extract the above-described correction information used as a provisional value in a case where the correction table 50 does not have the correction information associated with the model information received in step S201.

In addition, the management unit 320 may receive an operation for a process of updating the correction table 50 such as adding correction information associated with a certain model.

Next, the control application 220 preserves the correction information downloaded in step S202 (S203).

The correction information preserved in step S203 is then used for a correction process in the communication for distance estimation (S204) as described with reference to FIG. 3.

As described above, it is possible to consider that the control application 220 according to the present embodiment includes a program which causes a computer to implement an extraction function of extracting the correction information from the correction table 50 on the basis of the model information for the portable apparatus 20. The correction information is used to correct the radio wave strength of signals that are transmitted and received between the mobile body 10 and the portable apparatus 20. The correction table 50 is updated and managed by the management apparatus 30.

If described in more detail, the above-described program included in the control application 220 according to the present embodiment controls the download of the correction information from the management apparatus 30 that is based on the upload of the model information to the management apparatus 30.

According to the configuration as described above, it is possible to effectively manage correction information having high precision and estimate distance with high precision by using the correction information.

It should be noted that FIG. 4 exemplifies a case where communication is performed between the management apparatus 30 that is a server which distributes a digital key and the portable apparatus 20, but the communication between the management apparatus 30 and the portable apparatus 20 may be relayed to a server or the like included in a service provider that provides, for example, a digital key service.

Next, a case where the correction table 50 is also preserved in the control application 220 will be described.

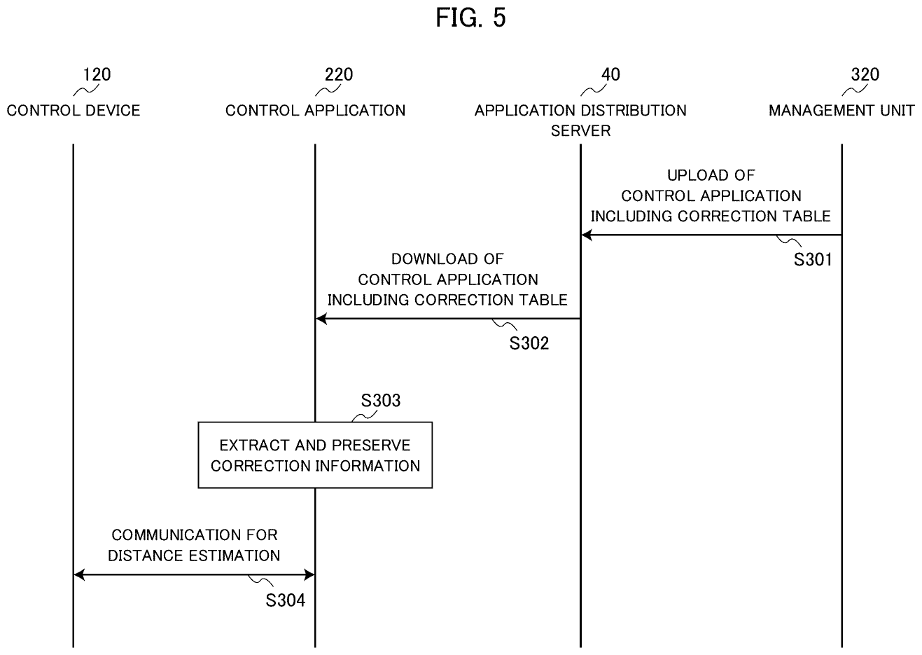

FIG. 5 is a sequence diagram illustrating an example of a flow of processes performed in a case where the correction table 50 according to the present embodiment is also preserved in the control application 220 installed in the portable apparatus 20.

It should be noted that FIG. 5 exemplifies a case where an application distribution server 40 included in a third party distributes the control application 220.

In the case of the example illustrated in FIG. 5, the management unit 320 first controls the upload of the control application 220 including the correction table 50 to the application distribution server 40 on the basis of an operation by the provider or the like (S301).

It should be noted that, in a case where the correction table 50 has an update, the management unit 320 controls the re-upload of the control application 220 including the updated correction table 50 to the application distribution server 40.

Next, the control application 220 including the correction table 50 is downloaded from the application distribution server 40 to the portable apparatus 20 on the basis of an operation by a user, and the control application 220 is installed in the portable apparatus 20 (S302).

In a case where the correction table 50 has an update, the control application 220 may be re-downloaded and re-installed on the basis of an operation or the like by a user.

When a digital key is used, the control application 220 installed in the portable apparatus 20 extracts the correction information from the correction table 50 stored in the control application 220 itself by using the model information as a key, and preserves the extracted correction information (S303).

It should be noted that the control application 220 may extract the above-described correction information that is used as a provisional value in a case where the correction table 50 does not have the correction information associated with the model information.

In addition, the control application 220 may re-extract and re-preserve correction information whenever re-downloaded and re-installed.

The correction information preserved in step S303 is then used for a correction process in the communication for distance estimation (S304) as described with reference to FIG. 3.

As described above, it is possible to consider that the control application 220 according to the present embodiment includes a program which causes a computer to implement an extraction function of extracting the correction information from the correction table 50 on the basis of the model information for the portable apparatus 20. The correction information is used to correct the radio wave strength of signals that are transmitted and received between the mobile body 10 and the portable apparatus 20. The correction table 50 is updated and managed by the management apparatus 30.

If described in more detail, the control application 220 according to the present embodiment includes the program described above and the correction table 50, and the program described above controls the download of the updated control application 220 from the management apparatus 30.

According to the configuration as described above, it is possible to effectively manage correction information having high precision and estimate distance with high precision by using the correction information.

Next, a case where the correction table 50 is also preserved in the control device 120 mounted on the mobile body 10 will be described.

The correction table 50 according to the present embodiment may be stored in the control device 120 in advance at the time of shipment.

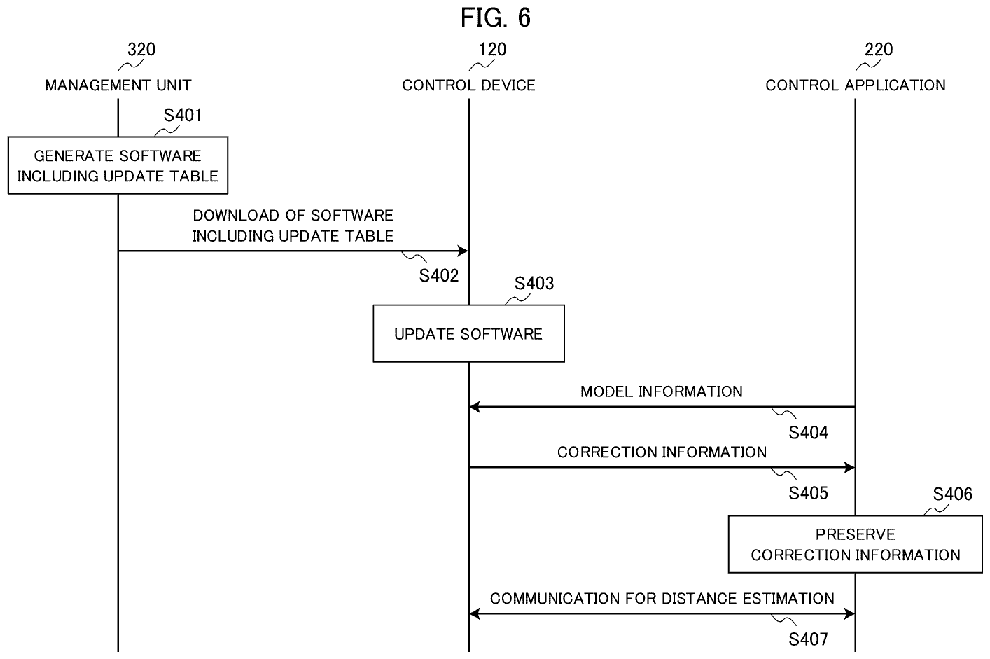

FIG. 6 is a sequence diagram illustrating an example of a flow of processes performed in a case where the correction table 50 according to the present embodiment is also preserved in the control device 120.

It should be noted that FIG. 6 illustrates an example of a case where the correction table 50 has an update after the shipment of the control device 120.

In this case, the management unit 320 generates software including the updated correction table 50 (update table) on the basis of an operation by the provider or the like (S401).

The software including the update table that is generated in step S401 is downloaded to the control device 120 by over the air (OTA) (S402) and the software is updated by the control device 120 (S403).

It should be noted that the control device 120 may update the software by using a diagnosis tool or the like connected to the control device 120 in a wired manner. The control application 220 mounted on the portable apparatus 20 performs control to cause the model information to be transmitted to the control device 120 when the digital key is used (S404).

The control device 120 that receives the model information in step S404 extracts the correction information from the correction table 50 by using the model information as a key and performs control to cause the extracted correction information to be returned to the control application 220 (S405).

It should be noted that the control device 120 may extract the above-described correction information used as a provisional value in a case where the correction table 50 does not have the correction information associated with the model information received in step S404.

Next, the control application 220 preserves the correction information returned in step S405 (S406).

The correction information preserved in step S406 is then used for a correction process in the communication for distance estimation (S407) as described with reference to FIG. 3.

As described above, it is possible to consider that the control device 120 according to the present embodiment includes a program which causes a computer to implement an extraction function of extracting the correction information from the correction table 50 on the basis of the model information for the portable apparatus 20. The correction information is used to correct the radio wave strength of signals that are transmitted and received between the mobile body 10 and the portable apparatus 20. The correction table 50 is updated and managed by the management apparatus 30.

If described in more detail, the above-described program included in the control device 120 according to the present embodiment controls the download of the updated correction table 50 from the management apparatus 30.

According to the configuration as described above, it is possible to effectively manage correction information having high precision and estimate distance with high precision by using the correction information.

### 2. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

In addition, the series of processes performed by each of the devices described herein may be achieved by a program stored in a non-transitory computer readable storage medium. For example, each program is loaded into RAM, and executed by a processor such as a CPU when a computer executes each of the program. The storage medium may be a magnetic disk, an optical disc, a magneto-optical disc, flash memory, or the like, for example. Alternatively, the above-described programs may be distributed via a network without using the storage medium, for example.

What is claimed is:

1. A control system comprising:
a non-transitory computer readable storage medium storing a program that causes a computer to implement an extraction function of extracting correction information from a correction table on a basis of model information for a portable apparatus, the correction information being used to correct radio wave strength of signals that are transmitted and received between a mobile body and the portable apparatus, the correction table being updated and managed by a server; and
a determination device configured to determine on a basis of radio wave strength whether or not to cause a control target device to execute a prescribed operation, the radio wave strength being corrected by using the correction information, the control target device being mounted on the mobile body.

2. The control system according to claim 1, wherein
the program is installed in the portable apparatus, and
the program controls download of the correction information from the server, the download being based on upload of the model information to the server.

3. The control system according to claim 1, wherein
an application including the program and the correction table is installed in the portable apparatus, and
the program controls download of the updated application from the server.

4. The control system according to claim 1, wherein
the program is installed in a control device that is mounted on the mobile body, and
the program controls download of the updated correction table from the server.

5. The control system according to claim 1, wherein the extraction function extracts the correction information that is provisional correction information in a case where the model information for the portable apparatus is not registered in the correction table.

6. A management apparatus comprising
a management unit configured to manage correction information and model information for a portable apparatus in association with each other, the correction information being used to correct radio wave strength of signals that are transmitted and received between a mobile body and the portable apparatus, wherein
radio wave strength corrected by using the correction information is used to determine whether or not to cause a control target device to execute a prescribed operation, the control target device being mounted on the mobile body.
